(19) United States
(12) Patent Application Publication
(10) Pub. No.: US 2024/0326740 A1
(43) Pub. Date: Oct. 3, 2024

(54) VEHICLE DOOR UNLOCKING SYSTEM

(71) Applicant: Honda Motor Co., Ltd., Tokyo (JP)

(72) Inventor: Naoyuki URUSHIZAKI, Tokyo (JP)

(73) Assignee: Honda Motor Co., Ltd., Tokyo (JP)

(21) Appl. No.: 18/416,922

(22) Filed: Jan. 19, 2024

(30) Foreign Application Priority Data
Mar. 30, 2023 (CN) 202310327697.2

(51) Int. Cl. B60R 25/24; B60R 25/01; B60R 25/25; B60R 25/30; G06V 20/56; G06V 40/16; G07C 9/00; G07C 9/25

(52) U.S. Cl. CPC B60R 25/24; B60R 25/01; B60R 25/25; B60R 25/305; G06V 20/56; G06V 40/172; G07C 9/00309; G07C 9/25; G07C 2009/00793; G07C 2209/63

(57) ABSTRACT

A vehicle door unlocking system considering convenience and safety of door unlocking is disclosed. The vehicle door unlocking system utilizes a communication terminal capable of communicating wirelessly with a vehicle to unlock a vehicle door, and includes: a receiving portion receiving an unlocking command issued by an operation of a user; and a recognition portion recognizing a position of the user relative to the vehicle. When the receiving portion receives an unlocking command issued from a position more than a first distance away from the vehicle by a first operation of the user, or when the receiving portion receives an unlocking command issued by a second operation of the user, a standby mode is shifted to. When the recognition portion in the standby mode recognizes that the user enters a position within a second distance that is less than the first distance from the vehicle, the vehicle door is unlocked.

### CROSS-REFERENCE TO RELATED APPLICATION

This application claims the priority benefit of China application serial no. 202310327697.2, filed on Mar. 30, 2023. The entirety of the above-mentioned patent application is hereby incorporated by reference herein and made a part of this specification.

### BACKGROUND

### Technical Field

This disclosure relates to a vehicle door unlocking system.

### Description of Related Art

In recent years, efforts to provide access to sustainable transportation systems that also take into account the disadvantaged position of transportation participants, such as the elderly, the disabled, or children, have become active. In order to achieve these aims, research and development are being conducted to further improve the safety and convenience of transportation through developments related to improved operability. However, the convenience and safety of unlocking the doors of a vehicle is an issue in the development related to improving operability.

In the existing technology, there are technical solutions for unlocking a door of a vehicle by wireless communication using a communication terminal such as a portable machine (e.g., a smart key) or a mobile device (e.g., a smartphone) held by a user. However, it is difficult for the user to operate these communication terminals to unlock the vehicle door by hand when the user is holding an object in his or her hand. Therefore, there is a method in which a sensor is mounted underneath a door and the user can unlock the door by contacting the door with his/her foot (e.g., kicking). However, such an action may cause the user's balance to be disrupted, and there is a risk of falling. Accordingly, if the user is allowed to unlock the vehicle remotely by operating these communication terminals manually beforehand, the lack of convenience in unlocking the doors is solved, but the safety of unlocking the doors is reduced because there is a possibility that the doors may be opened by another person before the user moves to the vicinity of the vehicle for the purpose of theft.

The disclosure aims to solve the above-mentioned problem by balancing the convenience and safety of door unlocking. Moreover, it contributes to the development of a sustainable transportation system by further improving the safety of transportation.

### SUMMARY

The disclosure provides a vehicle door unlocking system, capable of balancing the convenience of vehicle door unlocking with safety.

The disclosure provides a vehicle door unlocking system, utilizing a communication terminal capable of communicating wirelessly with a vehicle to unlock a vehicle door, and including: a receiving portion receiving an unlocking command issued by an operation of a user; and a recognition portion recognizing a position of the user relative to the vehicle. When the receiving portion receives an unlocking command issued from a position more than a first distance away from the vehicle by a first operation of the user, or when the receiving portion receives an unlocking command issued by a second operation of the user, the vehicle door unlocking system shifts to a standby mode. When the recognition portion in the standby mode recognizes that the user enters a position within a second distance that is less than the first distance from the vehicle, the vehicle door is unlocked.

In an embodiment of the disclosure, the recognition portion recognizes whether the user enters the position within the second distance from the vehicle according to a current position information of the communication terminal pre-registered in the vehicle. When the recognition portion in the standby mode completes position recognition of the current position information of the communication terminal, the vehicle door is unlocked.

In an embodiment of the disclosure, the recognition portion recognizes whether the user enters the position within the second distance from the vehicle according to facial recognition information of the user acquired by an external camera mounted on the vehicle. When the recognition portion in the standby mode completes facial recognition of the user, the vehicle door is unlocked.

In an embodiment of the disclosure, the first operation and the second operation of the user are performed by the communication terminal held by the user.

In an embodiment of the disclosure, the vehicle door comprises a tailgate of the vehicle.

Based on the above, in the vehicle door unlocking system of the disclosure, when the receiving portion receives an unlocking command issued from a position more than a first distance away from the vehicle by a first operation of the user, or when the receiving portion receives an unlocking command issued by a second operation of the user, the vehicle door unlocking system shifts to a standby mode. When the recognition portion in the standby mode recognizes that the user enters a position within a second distance that is less than the first distance from the vehicle, the vehicle door is unlocked. In this way, the user is able to issue an unlocking command by performing a first operation on the vehicle remotely (at more than a first distance from the vehicle) in advance, or by performing a second operation on the vehicle regardless of distance. Before the user approaches the vehicle, the vehicle door unlocking system, which receives the unlocking command, is in standby mode and has not yet unlocked the vehicle door. Further, if the user approaches the vehicle (into a position within a second distance from the vehicle), the vehicle door unlocking system may automatically unlock the vehicle door after recognition in the standby mode by a recognition mechanism that does not require the use of hands. Accordingly, the vehicle door unlocking system of the disclosure is able to balance the convenience of vehicle door unlocking with safety.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a schematic diagram of operation of wireless communication between a vehicle door unlocking system and a vehicle according to an embodiment of the disclosure.

FIG. 2 is a schematic diagram of functional components of the vehicle door unlocking system shown in FIG. 1.

FIG. 3 is a schematic diagram of operation of the vehicle door unlocking system shown in FIG. 2 when performing a remote first operation.

FIG. 4 is a schematic diagram of an operation flow of the vehicle door unlocking system shown in FIG. 2.

### DESCRIPTION OF THE EMBODIMENTS

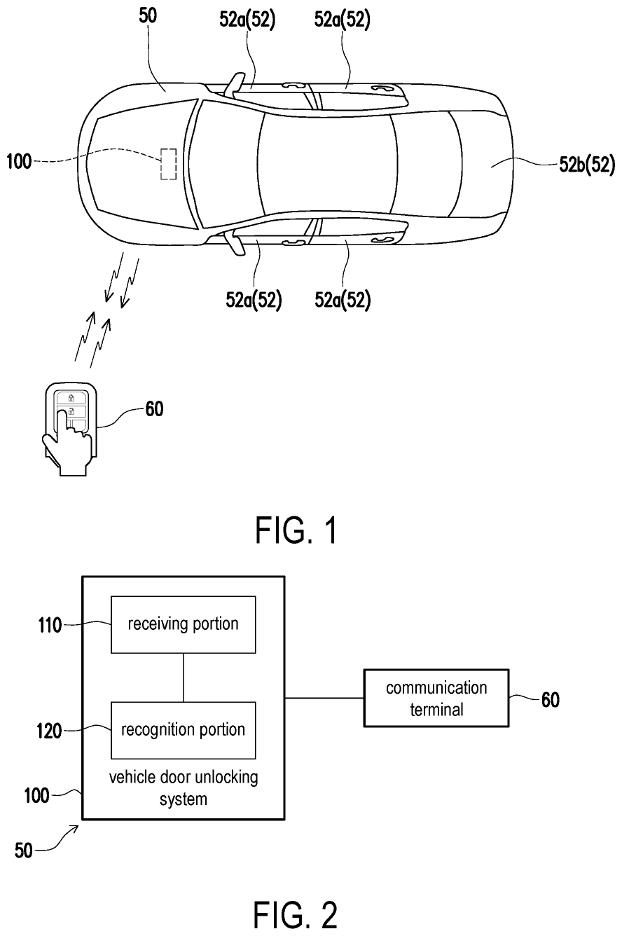

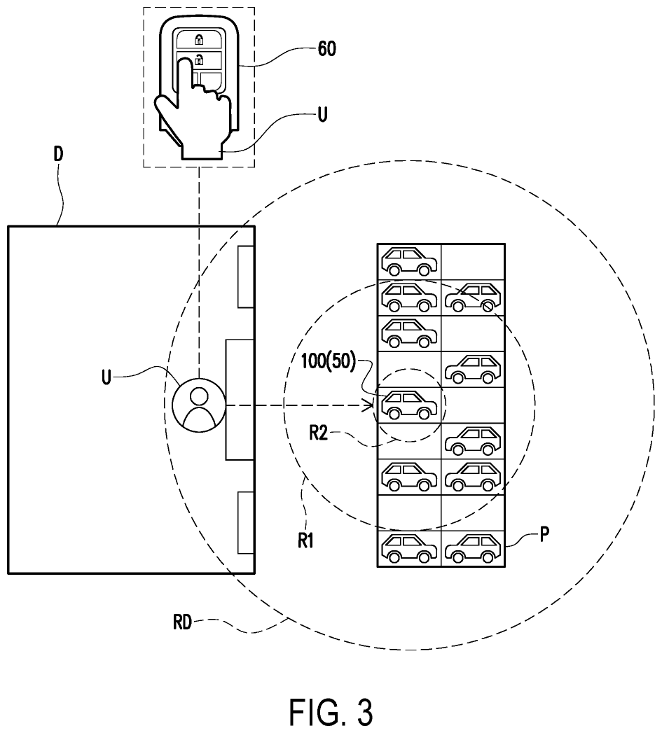

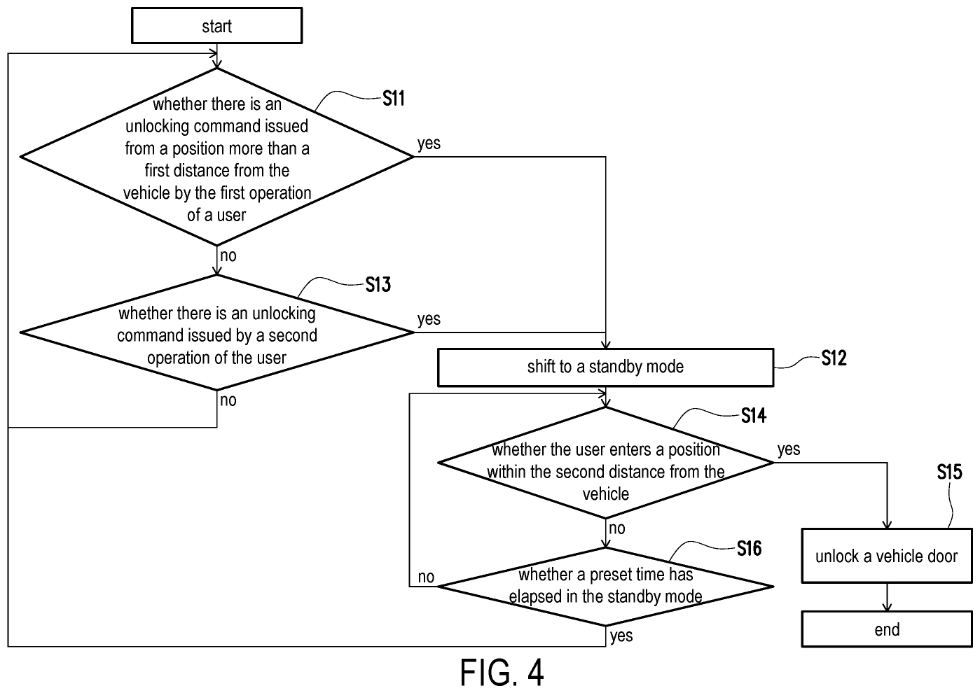

FIG. 1 is a schematic diagram of operation of wireless communication between a vehicle door unlocking system and a vehicle according to an embodiment of the disclosure. FIG. 2 is a schematic diagram of functional components of the vehicle door unlocking system shown in FIG. 1. FIG. 3 is a schematic diagram of operation of the vehicle door unlocking system shown in FIG. 2 when performing a remote first operation. FIG. 4 is a schematic diagram of an operation flow of the vehicle door unlocking system shown in FIG. 2. The specific composition and operation method of a vehicle door unlocking system 100 of this embodiment will be described below with reference to FIG. 1 to FIG. 4, but this is only one example, and the disclosure is not limited thereto, and it can be adjusted according to needs.

Please refer to FIG. 1 to FIG. 3. In this embodiment, the vehicle door unlocking system 100 utilizes a communication terminal 60 capable of communicating wirelessly with a vehicle 50 to unlock a vehicle door 52 of the vehicle 50. The communication terminal 60 is, for example, a portable machine (e.g., a smart key) or a mobile device (e.g., a smartphone) held by a user U, but is not limited thereto. The vehicle door unlocking system 100 is installed in the vehicle 50 and includes a receiving portion 110 and a recognition portion 120. The receiving portion 110 is executed by a communication device (not shown) mounted on the vehicle 50, for example, and receives an unlocking command issued by an operation of the user U, but is not limited thereto. Correspondingly, the recognition portion 120 is executed by, for example, a central control device (not shown) or a processing device mounted on the vehicle 50 to recognize a position of the user U relative to the vehicle 50, but is not limited thereto. In this way, when the receiving portion 110 receives an unlocking command issued from a position more than a first distance R1 from the vehicle 50 by the first operation of the user U, the vehicle door unlocking system 100 shifts to a standby mode. Alternatively, when the receiving portion 110 receives an unlocking command issued by a second operation of the user U, the vehicle door unlocking system 100 shifts to the standby mode. Furthermore, when the recognition portion 120 in the standby mode recognizes that the user U enters a position within the second distance R2 that is less than the first distance R1 from the vehicle 50, the vehicle door 52 is unlocked.

As an example, as shown in FIG. 2 to FIG. 4, an operation flow of the vehicle door unlocking system 100 includes the following steps. First, in step S11, it is determined whether there is an unlocking command issued from a position more than the first distance R1 from the vehicle 50 by the first operation of the user U. The first distance R1 is, for example, a distance at which the periphery of the vehicle 50 cannot be seen from the position where the user U is located (i.e., remotely), and an upper limit value R0 of the first distance R1 is a distance at which the communication terminal 60 held by the user U is unable to communicate wirelessly with the receiving portion 110 (e.g., as performed by a communication device) of the vehicle door unlocking system 100 (e.g., the door unlocking system 100) mounted to the vehicle 50 to receive the unlocking command. That is, when the user U is located at a position greater than the upper limit value R0 of the first distance R1 from the vehicle 50, the unlocking command issued by the communication terminal 60 held by the user U cannot be received by the receiving portion 110 via wireless communication. Preferably, the first operation of the user U is performed by the communication terminal 60 held by the user U. For example, as shown in FIG. 4, when the user U is in the vicinity of the doorway of a building D, such as a store, and is not yet holding an item (e.g., placing a purchased item temporarily on a table in the store), the user U issues an unlocking command to the vehicle 50 located in a parking lot P in advance by using the communication terminal 60 (e.g., a portable machine or a mobile device or the like) held by the user U to remotely (at more than the first distance R1 from the vehicle 50) perform the first operation to the vehicle 50, e.g., by pressing once an unlocking button on the portable machine or clicking once on an unlocking screen of the mobile device, or the like.

In this case, if it is determined in step S11 that there is an unlocking command issued from a position more than the first distance R1 from the vehicle 50 by the first operation of the user U (step S11: yes), then if the receiving portion 110 receives the unlocking command, the vehicle door unlocking system proceeds to step S12 and shifts to the standby mode. The standby mode means that the vehicle door 52 has not yet been unlocked, but is capable of being unlocked by a further judgment mechanism (e.g., a recognition mechanism performed by the recognition portion 120 described subsequently). In this way, the user U is able to issue an unlocking command by performing a first operation on the vehicle 50 remotely (at more than the first distance R1 from the vehicle 50) beforehand. Before the user U approaches the vehicle 50, the vehicle door unlocking system 100 receiving the unlocking command is in the standby mode and has not yet unlocked the vehicle door 52. By setting the standby mode, even if the user U is in a position at more than the first distance R1 from the vehicle 50 and cannot see the surrounding conditions of the vehicle 50, the user U does not have to worry about a situation in which the vehicle door 52 is opened by another person to steal before moving to the vicinity of the vehicle 50 because the vehicle door 52 has not yet been unlocked at that time. Accordingly, the vehicle door unlocking system of the disclosure is able to balance the convenience of vehicle door unlocking with safety.

Correspondingly, in this embodiment, if it is determined in step S11 that there is no unlocking command issued from a position more than the first distance R1 from the vehicle 50 by the first operation of the user U (step S11: no), then in step S13, it is further determined whether there is an unlocking command issued by the second operation of the user U. Preferably, the second operation of the user U is performed by the communication terminal 60 held by the user U. For example, when the user U is in the vicinity of the doorway of a building D, such as a store, and is not yet holding an item (e.g., placing a purchased item temporarily on a table in the store), the user U issues an unlocking command to the vehicle 50 located in a parking lot P by using the communication terminal 60 (e.g., a portable machine or a mobile device or the like) held by the user U to perform the second operation to the vehicle 50, e.g., by long-pressing an unlocking button on the portable machine or long-touching an unlocking screen of the mobile device, or the like. Alternatively, in the case where the user U does not have an object in hand and it is difficult to operate the communication terminal 60 by hand to unlock the vehicle door, the user U may wait until he or she moves to the vicinity of the vehicle 50 (within the first distance R1 from the vehicle 50) to perform the second operation on the vehicle 50 using the communication terminal 60 (e.g., a portable machine or a mobile device or the like) held by the user to issue an unlocking command to the vehicle 50.

In this case, if it is determined in step S13 that there is an unlocking command issued by the second operation of the user U (step S13: yes), then if the receiving portion 110 receives the unlocking command issued by the second operation of the user U, the vehicle door unlocking system proceeds to step S12 and shifts to the standby mode. In this way, the user U may perform the second operation on the vehicle 50 to issue an unlocking command regardless of the distance (as long as the distance is within the upper limit value R0 and wireless communication is possible). Accordingly, the vehicle door unlocking system 100 may take into account the convenience of unlocking the vehicle door. Correspondingly, if it is determined in step S13 that there is no unlocking command issued by the second operation of the user U (step S13: no), i.e., the unlocking command of the user U is issued from a position above the upper limit value R0 of the first distance R1 from the vehicle 50 and is not received by the receiving portion 110 via wireless communication, or the unlocking command is not issued correctly by the user U because the user U did not succeed in executing the first or the second operation, or the user U does not carry out any operation to issue the unlocking command, an initial state is resumed without unlocking the vehicle door 52 or shifting to the standby mode.

In addition, in this embodiment, the first operation and the second operation may be may be modes of operation in which different operation times are performed for the same operation interface in the same communication terminal 60 held by the user U. For example, the first operation is to press the unlocking button on the portable machine once while the second operation is to press the unlocking button on the portable machine for a prolonged period of time. Alternatively, the first operation and the second operation may be modes of operation for performing operations on different interfaces in the same communication terminal 60 held by the user U. For example, the first operation is to press a first unlocking button on the portable machine and the second operation is to press a second unlocking button on the portable machine. Further, the first operation and the second operation may also be an operation mode in which the operation is performed via different communication terminals 60 held by the user U. For example, the first operation is to touch the unlocking screen of the mobile device, while the second operation is to press the unlocking button on the portable machine. In this way, the disclosure does not limit the specific implementation of the first operation and the second operation, which may be adjusted according to the needs.

Furthermore, in this embodiment, after shifting to the standby mode of step S12, in step S14, it is determined whether the user U enters a position within the second distance R2 from the vehicle 50. That is, after the vehicle door unlocking system 100 shifts to the standby mode, the recognition portion 120 in the standby mode recognizes whether the user U enters a position within the second distance R2 from the vehicle 50. The second distance R2 is, for example, a distance at which the user U is located in a position where the user U can see the periphery of the vehicle 50 and the recognition portion 120 is able to recognize the user U. In particular, the second distance R2 is, for example, a distance at which the user U is located near the vehicle door 52 of the vehicle 50. In this case, if it is determined in step S14 that the user U has entered a position within the second distance R2 from the vehicle 50 (step S14: yes), then if the recognition portion 120 in the standby mode recognizes that the user U has entered a position within the second distance R2 from the vehicle 50, step S15 is proceeded to unlock the vehicle door 52, and the present process ends.

Correspondingly, if it is determined in step S14 that the user U has not entered a position within second distance R2 from the vehicle 50 (step S14: no), then it is further determined in step S16 whether the preset time has elapsed in the standby mode. If it is determined in step S16 that the preset time has elapsed in the standby mode (step S16: yes), i.e., the user U may not have continued to move toward the vehicle 50 and may be regarded as having no need for unlocking, the initial state is resumed without unlocking the vehicle door 52 or maintaining the standby mode. If it is determined in step S16 that the preset time has not elapsed in the standby mode (step S16: no), the user U may still be in the process of moving toward the vehicle 50 from a distance, thereby maintaining the standby mode in response to the unlocking demand of the user U, and proceeding once again to step S14 to determine whether or not the user U has entered into a position that is within the second distance R2 from the vehicle 50, until it is determined in step S14 that the user U has entered a position within the second distance R2 from the vehicle 50 (step S14: yes) and proceeds to step S15 to unlock the vehicle door 52, or until it is determined in step S16 that the preset time has elapsed in the standby mode (step S16: yes) and then the initial state is restored. As can be seen, in the case where the user U approaches the vehicle 50 (into a position within a second distance R2 from the vehicle 50), the vehicle door unlocking system 100 is able to automatically unlock the vehicle door in the standby mode upon completion of the recognition by a hand-free recognition mechanism. Furthermore, in the case where the user U is not recognized by the recognition portion 120 in the standby mode as having entered a position within the second distance R2 from the vehicle 50, a vehicle door locking effect may be maintained by resuming the initial setting after a preset time has elapsed. Accordingly, the vehicle door unlocking system of the disclosure is able to balance the convenience of vehicle door unlocking with safety.

As one of the recognition mechanisms of the recognition portion 120, the recognition portion 120 recognizes whether the user U has entered a position within the second distance R2 from the vehicle 50 according to a current position information of the communication terminal 60 (e.g., a portable machine or mobile device or the like) that is pre-registered in the vehicle 50. For example, after the user U issues an unlocking command by an operation (a first operation or a second operation) of the communication terminal 60, the vehicle 50 is capable of detecting, in real time, the current position information of the communication terminal 60, which is pre-registered in the vehicle 50, to determine whether or not the user U has moved to a position that is within a second distance R2 from the vehicle 50. In the case where the recognition portion 120 in the standby mode has not yet completed position identification of the current position information of the communication terminal 60 (e.g., the user U is still at a position more than the second distance R2 from the vehicle 50 and has not yet moved to the vicinity of the vehicle 50), the standby mode is maintained until a preset time is elapsed. The vehicle door 52 is unlocked in the event that the recognition portion 120 completes position recognition of the current position information of the communication terminal 60 in the standby mode. In this way, the vehicle door unlocking system 100 is capable of automatically unlocking the door in the standby mode upon completion of the recognition via a hand-free recognition mechanism (e.g., position recognition authentication of the communication terminal 60). Accordingly, the vehicle door unlocking system 100 may take into account the convenience of unlocking the vehicle door. However, the communication terminal 60 which is one of the recognition mechanisms of the recognition portion 120 is not limited to being the same communication terminal 60 used to perform the first operation or the second operation for issuing the unlocking command as described previously, but may also be performed by a different communication terminal 60 (e.g., the first operation and the second operation are performed by a portable machine, and the recognition mechanism is performed by a mobile device) as long as a registration is performed beforehand. The disclosure is not limited thereto, but may be adjusted according to the needs.

Alternatively, as one of the recognition mechanisms of the recognition portion 120, the recognition portion 120 recognizes whether the user U enters the position within the second distance R2 from the vehicle 50 according to facial recognition information of the user U acquired by an external camera (not shown) mounted on the vehicle 50. For example, after the user U issues an unlocking command by an operation (the first operation or the second operation) on the communication terminal 60, a central control device or a processing device of the vehicle 50 may activate the external camera mounted on the vehicle 50 to capture external images of the vehicle 50 to determine whether the user U has moved to a position within the second distance R2 from the vehicle 50. In the case where the recognition portion 120 has not yet completed facial recognition of the user U in the standby mode (e.g., the user U is still at a position more than the second distance R2 from the vehicle 50 and has not yet moved to the vicinity of the vehicle 50), the standby mode is maintained until a preset time has been elapsed. The vehicle door 52 is unlocked in the event that the recognition portion 120 completes facial recognition of the user U in the standby mode. In this way, the vehicle door unlocking system 100 may automatically unlock after completing the recognition through a hands-free recognition mechanism (e.g., facial recognition authentication of the user U) in the standby mode. Accordingly, the vehicle door unlocking system 100 may take into account the convenience of unlocking the vehicle door. However, the external camera which is one of the recognition mechanisms of the recognition portion 120 is not limited to the position set up, nor is it limited to recognizing the face of the user U, as long as it is capable of recognizing and authenticating the user U himself (preferably an authentication method which does not require the use of hands). The disclosure is not limited thereto, and it may be adjusted according to the needs.

Furthermore, in this embodiment, as shown in FIG. 1, as an example, the vehicle door 52 of the vehicle 50 includes four side doors 52a and a flip-up tailgate 52b. For the flip-up tailgate 52b, it is assumed that the user U tends to place the items in the trunk when holding the items in the hand and needs to open the tailgate 52b. It is also assumed that it is difficult for the user U to open the flip-up tailgate 52b while holding the items in hand. Accordingly, the unlocking mechanism for the vehicle door unlocking system 100 to unlock the vehicle door 52 of the vehicle 50 preferably refers to unlocking the tailgate 52b of the vehicle 50, while other side doors 52a are unlocked in the existing general unlocking method. Alternatively, the vehicle door unlocking system 100 may also unlock all vehicle doors 52 at once. In addition, the vehicle door unlocking system 100 is not limited to the side doors 52a or the tailgate 52b of the vehicle 50 that allows passengers or items to enter the side door 52 of the vehicle compartment, but can also be trunk doors, hoods, convertible tops, and other doors capable of being opened or closed relative to the vehicle body of the vehicle 50. The disclosure does not limit the specific structure of the vehicle 50 to which the vehicle door unlocking system 100 is applied and the unlocked door 52, which can be adjusted according to needs.

To sum up, in the vehicle door unlocking system of the disclosure, when the receiving portion receives an unlocking command issued from a position more than a first distance away from the vehicle by a first operation of the user, or when the receiving portion receives an unlocking command issued by a second operation of the user, the vehicle door unlocking system shifts to a standby mode. When the recognition portion in the standby mode recognizes that the user enters a position within a second distance that is less than the first distance from the vehicle, the vehicle door is unlocked. Preferably, the first operation and the second operation of the user is performed by the communication terminal (a portable machine or a mobile device or the like) held by the user U. In this way, the user is able to issue an unlocking command by performing a first operation on the vehicle remotely (at more than a first distance from the vehicle) in advance, or by performing a second operation on the vehicle regardless of distance. Before the user approaches the vehicle, the vehicle door unlocking system, which receives the unlocking command, is in standby mode and has not yet unlocked the vehicle door. Further, if the user approaches the vehicle (into a position within a second distance from the vehicle), the vehicle door unlocking system may automatically unlock the vehicle door after recognition in the standby mode by a recognition mechanism that does not require the use of hands. Accordingly, the vehicle door unlocking system of the disclosure is able to balance the convenience of vehicle door unlocking with safety.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vehicle door unlocking system, utilizing a communication terminal capable of communicating wirelessly with a vehicle to unlock a vehicle door, comprising:
a receiving portion, receiving an unlocking command issued by an operation of a user; and
a recognition portion, recognizing a position of the user relative to the vehicle, wherein
when the receiving portion receives an unlocking command issued from a position more than a first distance away from the vehicle by a first operation of the user, or when the receiving portion receives an unlocking command issued by a second operation of the user, the vehicle door unlocking system shifts to a standby mode, and
when the recognition portion in the standby mode recognizes that the user enters a position within a second distance that is less than the first distance from the vehicle, the vehicle door is unlocked.

2. The vehicle door unlocking system according to claim 1, wherein
the recognition portion recognizes whether the user enters the position within the second distance from the vehicle according to a current position information of the communication terminal pre-registered in the vehicle, and
when the recognition portion in the standby mode completes position recognition of the current position information of the communication terminal, the vehicle door is unlocked.

3. The vehicle door unlocking system according to claim 1, wherein
the recognition portion recognizes whether the user enters the position within the second distance from the vehicle according to facial recognition information of the user acquired by an external camera mounted on the vehicle, and
when the recognition portion in the standby mode completes facial recognition of the user, the vehicle door is unlocked.

4. The vehicle door unlocking system according to claim 1, wherein
the first operation and the second operation of the user are performed by the communication terminal held by the user.

5. The vehicle door unlocking system according to claim 2, wherein
the first operation and the second operation of the user are performed by the communication terminal held by the user.

6. The vehicle door unlocking system according to claim 3, wherein
the first operation and the second operation of the user are performed by the communication terminal held by the user.

7. The vehicle door unlocking system according to claim 1, wherein
the vehicle door comprises a tailgate of the vehicle.

8. The vehicle door unlocking system according to claim 2, wherein
the vehicle door comprises a tailgate of the vehicle.

9. The vehicle door unlocking system according to claim 3, wherein
the vehicle door comprises a tailgate of the vehicle.
